(19) United States
(12) Patent Application Publication
(10) Pub. No.: US 2025/0210862 A1
(43) Pub. Date: Jun. 26, 2025

(54) ELECTROMAGNETIC WAVE CONTROL ELEMENT

(71) Applicant: FUJIFILM Corporation, Tokyo (JP)

(72) Inventors: Wataru HOSHINO, Kanagawa (JP); Yukito SAITOH, Kanagawa (JP); Hideki YASUDA, Kanagawa (JP); Taketo OTANI, Kanagawa (JP)

(73) Assignee: FUJIFILM Corporation, Tokyo (JP)

(21) Appl. No.: 19/077,839

(22) Filed: Mar. 12, 2025

Related U.S. Application Data
(63) Continuation of application No. PCT/JP2023/035121, filed on Sep. 27, 2023.

(30) Foreign Application Priority Data
Sep. 27, 2022 (JP) 2022-153479

(51) Int. Cl. H01Q 3/46

(52) U.S. Cl. CPC H01Q 3/46

(57) ABSTRACT

An electromagnetic wave control element, with which a traveling direction of electromagnetic waves having a frequency of 0.1 to 0.3 THz can be switched in a short time. The electromagnetic wave control element is configured to have a liquid crystal layer in which an alignment state of a liquid crystal compound changes depending on a voltage, and a metasurface structure in which a plurality of microstructures are arranged, in this order, in which the liquid crystal layer includes an azo compound.

### CROSS-REFERENCE TO RELATED APPLICATIONS

This application is a Continuation of PCT International Application No. PCT/JP2023/035121 filed on Sep. 27, 2023, which was published under PCT Article 21(2) in Japanese, and which claims priority under 35 U.S.C. § 119 (a) to Japanese Patent Application No. 2022-153479 filed on Sep. 27, 2022. The above applications are hereby expressly incorporated by reference, in their entirety, into the present application.

### BACKGROUND OF THE INVENTION

### 1. Field of the Invention

The present invention relates to an electromagnetic wave control element using a metasurface structure.

### 2. Description of the Related Art

High-frequency radio waves (millimeter waves, terahertz waves) required for high-capacity wireless communication have high straightness. Therefore, for example, in order to deliver radio waves to the entire area in a room, a reflective plate that is attached to a wall or the like and bends radio waves in any direction is required.

However, a typical reflective plate exhibits specular reflection, and the incidence angle and the emission angle are equal. Therefore, for example, there was a problem that radio waves have difficulty reaching places such as the back of a room.

In contrast, a device that bends electromagnetic waves in a direction different from specular reflection using a dynamic element such as a liquid crystal is also disclosed.

For example, Jingbo Wu et al., Liquid crystal programmable metasurface for terahertz beam steering, Applied Physics Letters, 116, 131104 (2020) describes an electromagnetic wave control element (beam steering element) in which a liquid crystal layer 104 is interposed between a metasurface structure 100 and an electrode layer 102, as conceptually shown in FIG. 29.

In the electromagnetic wave control element shown in FIG. 29, the metasurface structure 100 is formed by arranging microstructures 100a serving as resonators, as in a known metasurface structure.

In this electromagnetic wave control element, the microstructures 100a constituting the metasurface structure 100 act not only as reflectors but also as electrodes. That is, the microstructures 100a and the electrode layer 102 constitute an electrode pair.

In addition, the electrode layer 102 also acts as a reflective layer of the incident electromagnetic waves.

The liquid crystal layer 104 is, as an example, formed by aligning the liquid crystal compound LC. In the example shown in FIG. 29, the liquid crystal compound LC is, as an example, a rod-like liquid crystal compound.

In the electromagnetic wave control element, in a state where no voltage is applied between the microstructures 100a and the electrode layer 102, the liquid crystal compound LC is aligned such that the longitudinal direction, that is, the direction of the optical axis coincides with the thickness direction.

In a case where a voltage is applied between the microstructures 100a and the electrode layer 102 in this state, the alignment state of the liquid crystal compound LC changes depending on the magnitude of the applied voltage.

In the example shown in the drawing, as an example, the liquid crystal compound LC is tilted with respect to the thickness direction depending on the magnitude of the voltage applied between the microstructures 100a and the electrode layer 102.

In FIG. 29, as an example, a high voltage is applied to the microstructure 100a on the left side in the drawing, and a low voltage is applied to the microstructure 100a on the right side in the drawing. As a result, the liquid crystal compound LC located in a region of the microstructure 100a on the left side in the drawing is largely tilted and the longitudinal direction is at an angle close to the main surface of the liquid crystal layer 104. On the other hand, the tilt of the liquid crystal compound LC located in a region of the microstructure 100a on the right side in the drawing is small and the longitudinal direction is at an angle close to the thickness direction of the liquid crystal layer 104.

The refractive index of the liquid crystal layer 104 increases as the tilt of the liquid crystal compound LC increases, that is, as the angle of the longitudinal direction of the liquid crystal compound LC is closer to a surface of the liquid crystal layer 104. Conversely, as the tilt of the liquid crystal compound LC decreases, that is, as the angle of the longitudinal direction of the liquid crystal compound LC is closer to the thickness direction of the liquid crystal layer 104, the refractive index of the liquid crystal layer 104 decreases.

Accordingly, in this state, the refractive index of the liquid crystal layer 104 is large in the region of the microstructure 100a on the left side in the drawing where the tilt of the liquid crystal compound LC is large, and is small in the region of the microstructure 100a on the right side in the drawing where the tilt of the liquid crystal compound LC is small.

Therefore, in the region of the microstructure 100a on the left side in the drawing where the refractive index is large, the phase of the incident electromagnetic waves is largely changed, as compared with the region of the microstructure 100a on the right side in the drawing where the refractive index is small.

As a result, in the region of the microstructure 100a on the left side in the drawing, the optical path of the electromagnetic waves is apparently long, as compared with the region of the microstructure 100a on the right side in the drawing.

Accordingly, in a case where electromagnetic waves are incident from the normal direction of the liquid crystal layer 104, even in electromagnetic waves that are simultaneously incident, the emission of electromagnetic waves incident on the region of the microstructure 100a on the left side in the drawing where the optical path length from the reflecting device is long is later than that of electromagnetic waves that are incident on the region of the microstructure 100a on the right side in the drawing where the optical path length is short.

As a result, electromagnetic waves incident from the normal direction into the reflecting device and reflected from the reflecting device are reflected to be tilted toward the left side such that wavefronts thereof are aligned instead of being specularly reflected in the normal direction.

### SUMMARY OF THE INVENTION

In the electromagnetic wave control element shown in FIG. 29, a voltage is applied between the microstructure 100a constituting the metasurface structure 100 and the electrode layer 102 to change the alignment state of the liquid crystal compound LC. In addition, the change in the alignment state changes depending on the voltage applied to the microstructure 100a.

Accordingly, by controlling the voltage applied to each microstructure 100a, incident electromagnetic waves can be reflected in a desired direction.

That is, in an electromagnetic wave control element using a metasurface structure and a liquid crystal layer, the reflection angle of incident electromagnetic waves can be switched by changing the voltage applied to each microstructure 100a.

However, in an electromagnetic wave control element using a metasurface structure and the liquid crystal layer in the related art, it takes time to switch the reflection direction of electromagnetic waves. Therefore, for example, in a case where it is necessary to deliver electromagnetic waves to a plurality of places by switching the reflection angle, there is a problem that the switching of the reflection direction cannot be performed at a sufficient speed.

An object of the present invention is to solve the problem of the related art as described above and to provide an electromagnetic wave control element that controls a traveling direction of electromagnetic waves using a metasurface structure and a liquid crystal layer, in which the electromagnetic wave control element can switch a traveling direction of electromagnetic waves having a frequency of 0.1 to 0.3 THz in a short time.

In order to accomplish the object, the present invention has the following configurations.

[1] An electromagnetic wave control element having:
a first electrode;
a liquid crystal layer in which an alignment state of a liquid crystal compound changes depending on a voltage; and
a metasurface structure in which a plurality of microstructures are arranged,
in which the electromagnetic wave control element acts on electromagnetic waves having a frequency of 0.1 to 0.3 THz, and
the liquid crystal layer includes an azo compound.

[2] The electromagnetic wave control element according to [1],
in which the azo compound has two or more azo structures.

[3] The electromagnetic wave control element according to [1] or [2].
in which the liquid crystal layer includes a liquid crystal compound having an azo structure.

[4] The electromagnetic wave control element according to any one of [1] to [3], further having:
a second electrode constituting an electrode pair together with the first electrode.

[5] The electromagnetic wave control element according to [4],
in which at least one of the first electrode or the second electrode is the microstructure.

[6] The electromagnetic wave control element according to any one of [1] to [5],
in which the microstructure constitutes an electrode pair together with the first electrode.

[7] The electromagnetic wave control element according to any one of [1] to [6],
in which the first electrode reflects electromagnetic waves having a frequency of 0.1 to 0.3 THz.

[8] The electromagnetic wave control element according to any one of [1] to [7],
in which the first electrode is a patterned electrode.

[9] The electromagnetic wave control element according to any one of [1] to [8],
in which the microstructure includes a metal.

[10] The electromagnetic wave control element according to any one of [1] to [9],
in which the microstructure includes an oxide semiconductor.

With the electromagnetic wave control element of the embodiment of the present invention, a traveling direction of electromagnetic waves having a frequency of 0.1 to 0.3 THz can be switched in a short time.

### BRIEF DESCRIPTION OF THE DRAWINGS

FIG. 1 is a view conceptually showing an example of an electromagnetic wave control element of an embodiment of the present invention.

FIG. 2 is a view conceptually showing an example of a liquid crystal alignment pattern in the electromagnetic wave control element of the embodiment of the present invention.

FIG. 3 is a view conceptually showing another example of the electromagnetic wave control element of the embodiment of the present invention.

FIG. 4 is a view conceptually showing another example of the electromagnetic wave control element of the embodiment of the present invention.

FIG. 5 is a view conceptually showing another example of the electromagnetic wave control element of the embodiment of the present invention.

FIG. 6 is a view conceptually showing another example of the electromagnetic wave control element of the embodiment of the present invention.

FIG. 7 is a view conceptually showing another example of the electromagnetic wave control element of the embodiment of the present invention.

FIG. 8 is a view conceptually showing another example of the electromagnetic wave control element of the embodiment of the present invention.

FIG. 9 is a view conceptually showing another example of the electromagnetic wave control element of the embodiment of the present invention.

FIG. 10 is a view conceptually showing another example of the electromagnetic wave control element of the embodiment of the present invention.

FIG. 11 is a view conceptually showing another example of the electromagnetic wave control element of the embodiment of the present invention.

FIG. 12 is a view conceptually showing another example of the electromagnetic wave control element of the embodiment of the present invention.

FIG. 13 is a view conceptually showing another example of the electromagnetic wave control element of the embodiment of the present invention.

FIG. 14 is a view conceptually showing another example of the electromagnetic wave control element of the embodiment of the present invention.

FIG. 15 is a view conceptually showing another example of the electromagnetic wave control element of the embodiment of the present invention.

FIG. 16 is a view conceptually showing another example of the electromagnetic wave control element of the embodiment of the present invention.

FIG. 17 is a view conceptually showing another example of the electromagnetic wave control element of the embodiment of the present invention.

FIG. 18 is a view conceptually showing another example of the electromagnetic wave control element of the embodiment of the present invention.

FIG. 19 is a view conceptually showing another example of the electromagnetic wave control element of the embodiment of the present invention.

FIG. 20 is a view conceptually showing another example of the electromagnetic wave control element of the embodiment of the present invention.

FIG. 21 is a view conceptually showing an example of a liquid crystal alignment pattern in the electromagnetic wave control element of the embodiment of the present invention.

FIG. 22 is a view conceptually showing another example of the liquid crystal alignment pattern in the electromagnetic wave control element of the embodiment of the present invention.

FIG. 23 is a view conceptually showing another example of the liquid crystal alignment pattern in the electromagnetic wave control element of the embodiment of the present invention.

FIG. 24 is a view conceptually showing another example of the liquid crystal alignment pattern in the electromagnetic wave control element of the embodiment of the present invention.

FIG. 25 is a view conceptually showing another example of the liquid crystal alignment pattern in the electromagnetic wave control element of the embodiment of the present invention.

FIG. 26 is a view conceptually showing another example of the electromagnetic wave control element of the embodiment of the present invention.

FIG. 27 is a schematic perspective view of the electromagnetic wave control element shown in FIG. 26.

FIG. 28 is a conceptual view for describing Example of the present invention.

FIG. 29 is a view conceptually showing an example of an electromagnetic wave control element in the related art.

### DESCRIPTION OF THE PREFERRED EMBODIMENTS

Hereinafter, the electromagnetic wave control element of the embodiment of the present invention will be described in detail based on suitable Examples shown in the accompanying drawings.

In the present specification, numerical ranges represented by “to” include numerical values before and after “to” as lower limit values and upper limit values.

In the present specification, the meaning of “the same” includes a case where an error range is generally allowed in the technical field.

Each of the drawings shown below is conceptual views for describing the electromagnetic wave control element of the embodiment of the present invention. Accordingly, a shape, a size, a thickness, a positional relationship, and the like of each of members do not necessarily match with the actual ones.

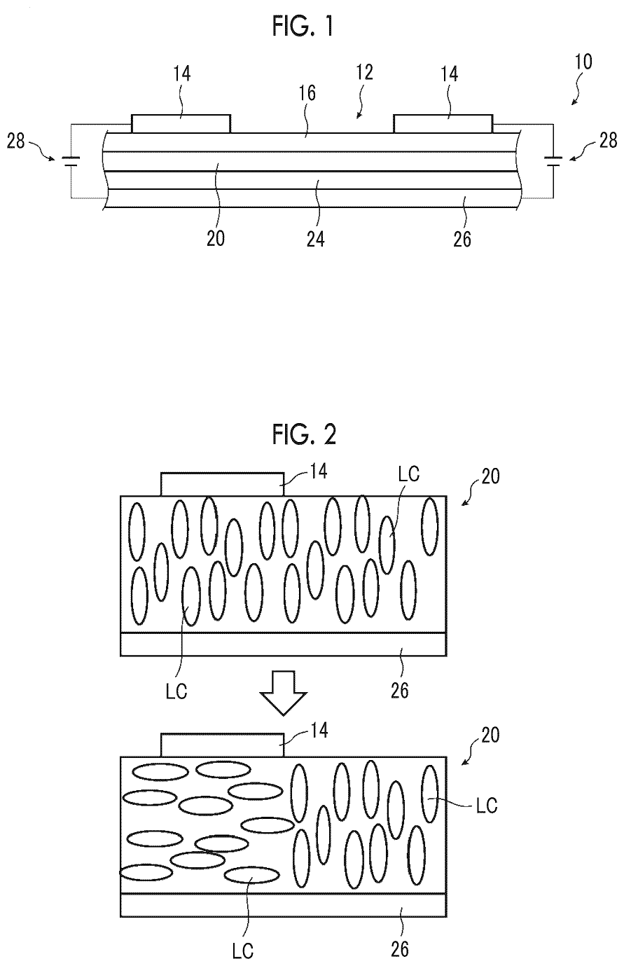

An example of the electromagnetic wave control element of the embodiment of the present invention is conceptually shown in FIG. 1.

An electromagnetic wave control element 10 of the embodiment of the present invention is a reflective type electromagnetic wave control element that uses a reflective type metasurface structure and a liquid crystal layer to direct a traveling direction of electromagnetic waves to a desired direction.

The electromagnetic wave control element of the embodiment of the present invention reflects electromagnetic waves having a frequency of 0.1 to 0.3 THz in a desired direction. That is, the electromagnetic wave control element of the embodiment of the present invention reflects electromagnetic waves having a wavelength of 1 to 3 mm in a desired direction.

As shown in FIG. 1, the electromagnetic wave control element 10 of the embodiment of the present invention includes, in the following order from the bottom in the drawing, a first electrode layer 26, a liquid crystal layer 20, and a metasurface structure 12.

The metasurface structure 12 is formed by two-dimensionally arranging microstructures 14 serving as resonators on a support body 16. In addition, the liquid crystal layer 20 is provided on a support body 24.

Furthermore, a first electrode layer 26 is provided to entirely cover the support body 24 opposite to the liquid crystal layer 20.

Furthermore, in the electromagnetic wave control element 10, the first electrode layer 26 and the support body 24, and the liquid crystal layer 20 and the support body 16 (metasurface structure 12) are bonded using a bonding agent (a pressure sensitive adhesive or an adhesive) as necessary.

The bonding method is not limited, and various known methods by which the electromagnetic waves as a target of the electromagnetic wave control element 10 can be transmitted, such as a method using an optical clear adhesive (OCA) through which the electromagnetic waves as a target of the electromagnetic wave control element 10 can be transmitted, can be used.

In the electromagnetic wave control element 10 shown in FIG. 1, as an example, the microstructure 14 is formed of a conductive material and also serves as an electrode constituting an electrode pair together with the first electrode layer 26. In addition, a power supply 28 for applying a voltage between the microstructure 14 and the first electrode layer 26 is connected to each of the microstructures 14.

In the electromagnetic wave control element 10 of the embodiment of the present invention, the alignment state of the liquid crystal compound changes depending on the application of a voltage in the liquid crystal layer 20.

Accordingly, by supplying power to each microstructure 14, a voltage is applied to the liquid crystal layer 20 between the microstructure 14 and the first electrode layer 26, and the alignment state of the liquid crystal compound LC varies. In addition, by adjusting the power supplied to each of the microstructures 14, the voltage applied to the region of the liquid crystal layer 20, corresponding to the microstructure 14, can be adjusted, and thus, the alignment state of the liquid crystal compound LC between the microstructure 14 and the first electrode layer 26 can be adjusted.

As an example, in the liquid crystal layer 20, the liquid crystal compound LC is aligned in the thickness direction of the liquid crystal layer 20 in a state where no voltage is applied, as conceptually shown in an upper part of FIG. 2. In the following description, this alignment state is also referred to as a “vertical alignment”.

In a case where power is supplied to the microstructure 14 and a voltage is applied to the liquid crystal layer 20, the alignment state of the liquid crystal compound LC in the region corresponding to the microstructure 14 changes depending on the strength of the applied voltage, and the liquid crystal compound LC is tilted with respect to the thickness direction of the liquid crystal layer 20, as conceptually shown in the lower part of FIG. 2. In the example shown in FIG. 2, the liquid crystal compound LC is aligned in a direction parallel to the main surface of the liquid crystal layer 20 at the maximum. In the following description, this alignment state is also referred to as a “horizontal alignment”.

Furthermore, in FIG. 2, in order to simplify the drawing, only the liquid crystal layer 20, the microstructure as the electrode, and the first electrode layer 26 are shown.

Furthermore, the thickness direction is a lamination direction of the first electrode layer 26, the support body 24, the liquid crystal layer 20, and the support body 16.

In addition, the main surface is a maximum surface of a sheet-like material (a film, a plate-like material, or a layer), and is usually on both surfaces of the sheet-like material in a thickness direction.

Furthermore, the normal direction is a direction orthogonal to a surface such as a main surface.

As described above, the electromagnetic wave control element 10 shown in FIG. 1 uses a reflective type metasurface structure and the first electrode layer 26 also serves as a reflective layer of electromagnetic waves.

In a case where electromagnetic waves are incident on the electromagnetic wave control element 10 of the embodiment of the present invention, having such a configuration, the electromagnetic waves are phase-modulated by resonance of the microstructure 14 (unit cell) in a case of transmitting through the metasurface structure 12, and further phase-modulated by being transmitted through the liquid crystal layer 20.

The electromagnetic waves are then reflected by the first electrode layer 26 that also serves as a reflective layer.

The electromagnetic waves reflected by the first electrode layer 26 are phase-modulated again by being transmitted through the liquid crystal layer 20, further phase-modulated by the metasurface structure 12, and thus emitted from the electromagnetic wave control element 10 as reflected electromagnetic waves.

Here, as described above, the alignment state of the liquid crystal compound LC in the liquid crystal layer 20, that is, the refractive index changes depending on the voltage applied to each microstructure 14.

The refractive index of the liquid crystal layer 20 is the smallest in a state where the liquid crystal compound LC is vertically aligned, increases as the inclination of the liquid crystal compound LC with respect to the thickness direction increases, and is the largest in a state of the horizontal alignment.

In a state where no voltage is applied to the liquid crystal layer 20, the liquid crystal compound LC in the liquid crystal layer 20 is vertically aligned. In a case where a voltage is applied to the liquid crystal layer 20, the liquid crystal compound LC in the region corresponding to the microstructure 14 is aligned to be tilted with respect to the thickness direction.

In the electromagnetic wave control element 10, as the voltage applied to the liquid crystal layer 20 increases, the liquid crystal compound LC is closer to the horizontal alignment and the refractive index of the liquid crystal layer 20 in the region increases. That is, in the liquid crystal layer 20, the refractive index of the region corresponding to the microstructure 14, that is, the phase difference imparted to the transmitted electromagnetic waves can be changed depending on the voltage applied to the microstructure 14.

Therefore, in the electromagnetic wave control element 10 of the embodiment of the present invention, by adjusting the power supplied to each microstructure 14 to adjust the voltage applied to the corresponding region, regions having different refractive indices in the plane direction of the liquid crystal layer 20 can be generated.

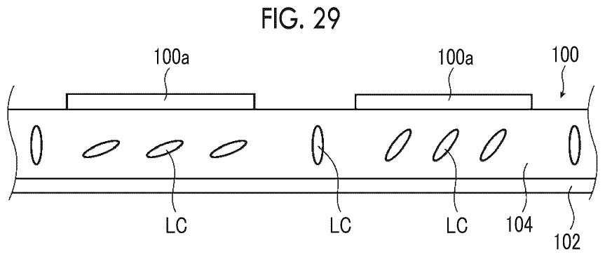

As a result, as with the electromagnetic wave control element (beam steering element) described in Jingbo Wu et al., Liquid crystal programmable metasurface for terahertz beam steering, Applied Physics Letters, 116, 131104 (2020) described with reference to FIG. 29, incident electromagnetic waves can be reflected in a direction different from specular reflection. For example, in a case where electromagnetic waves are incident from the normal direction of the liquid crystal layer 20, the electromagnetic waves are reflected in a direction tilted with respect to the normal direction instead of the normal direction.

In addition, by changing the power supplied to each microstructure 14 to change the voltage applied to the liquid crystal layer 20, the refractive index at each position in the plane direction can be changed, and thus, the reflection direction of the incident electromagnetic waves can be switched.

Furthermore, by adjusting the voltage applied to the liquid crystal layer 20, the reflected electromagnetic waves may be focused or diffused, and the focus and the degree of diffusion of the reflected electromagnetic waves may be switched.

The metasurface structure 12 is formed by two-dimensionally arranging the microstructures 14, which are microstructures, on the support body 16, in the same manner as a known metasurface structure.

In the metasurface structure 12 in the example shown in the drawing, the microstructures 14 are two-dimensionally arranged at regular intervals in the x direction and the y direction orthogonal to each other. In addition, in the metasurface structure 12, all the microstructures 14 are the same.

The support body 16 is not limited, and various known sheet-like materials can be used as long as the support body 16 can support the microstructure 14 and can transmit the electromagnetic waves having a frequency of 0.1 to 0.3 THz, which are targeted by the electromagnetic wave control element 10.

Examples of the support body 16 include a metal substrate having an oxide insulating layer such as a silicon substrate having silicon oxide, a support body consisting of an oxide such as silicon oxide, a support body consisting of a semiconductor such as germanium and chalcogenide glass, a resin film, for example, a polyacrylic resin film such as polymethyl methacrylate, a cellulose-based resin film such as cellulose triacetate, a cycloolefin polymer-based film, a polyethylene terephthalate (PET) film, a polycarbonate film, and a polyvinyl chloride resin film, and a glass plate. Examples of the cycloolefin polymer-based film include a product name “ARTON” manufactured by JSR Corporation, and a product name “ZEONOR” manufactured by Zeon Corporation.

The thickness of the support body 16 is not limited, and may be appropriately set depending on a material for forming the support body 16 such that it enables the microstructure 14 is supported, a sufficient transmittance with respect to electromagnetic waves having a frequency of 0.1 to 0.3 THz can be obtained, and a sufficient strength can be obtained depending on the use of the electromagnetic wave control element 10, and the like.

Furthermore, in the electromagnetic wave control element 10 of the embodiment of the present invention, the metasurface structure 12 is not limited to ones having the support body 16.

That is, in the electromagnetic wave control element of the embodiment of the present invention, the metasurface structure 12 may be formed by directly arranging the microstructures 14 on a surface of the liquid crystal layer 20 if possible.

The microstructures 14 are arranged on one surface of the support body 16. As a result, the metasurface structure 12 is formed.

The metasurface structure 12 is formed by two-dimensionally arranging the microstructures 14, which are microstructures, on a plane with a spacing therebetween, and is basically composed of an arrangement of unit cells formed by one microstructure 14 and a space around the microstructure 14.

In the electromagnetic wave control element 10 of the embodiment of the present invention, the metasurface structure is basically a known metasurface structure (metamaterial). Accordingly, in the electromagnetic wave control element 10 of the embodiment of the present invention, various known metasurface structures can be used.

That is, in the present invention, the shape and the material for forming the microstructure 14, the arrangement of the microstructures 14, the interval (pitch) of the microstructures 14, and the like are not limited.

In addition, the metasurface structure 12 may be designed by a known method, depending on the reflection characteristics of electromagnetic waves desired by the electromagnetic wave control element 10 of the embodiment of the present invention. As an example, the amplitude and the phase of the electromagnetic waves reflected by the microstructures 14 to be used may be calculated using commercially available simulation software, and the arrangement of the microstructures 14 may be set to obtain a desired phase modulation amount, that is, a distribution of a delay amount (refractive index) of the phase.

The electromagnetic wave control element 10 of the embodiment of the present invention is intended for electromagnetic waves having a frequency of 0.1 to 0.3 THz.

Accordingly, in the metasurface structure 12, the microstructure 14 is selected such that a desired phase difference is imparted to the electromagnetic waves having the frequency, and further, the arrangement of the microstructures, and the like are set.

The metasurface structure 12 is basically composed of an arrangement of unit cells formed of one microstructure 14 and a space around the microstructure 14. The metasurface structure 12 modulates the phase of incident electromagnetic waves by utilizing a resonance of the microstructure 14 by arranging the unit cells.

Furthermore, in the electromagnetic wave control element 10 of the embodiment of the present invention, the number of the microstructures 14 included in one unit cell is basically one, but the present invention is not limited thereto. That is, in the electromagnetic wave control element of the embodiment of the present invention, one unit cell may have a plurality of microstructures 14 as necessary depending on the desired optical characteristics, the size, the formation material, and the shape of the microstructure 14, the size of the unit cell, and the like. In this case, one unit cell may have different microstructures 14. It should be noted that in a case where one unit cell has the plurality of microstructures 14, basically, the phase modulation amounts in the space where each microstructure of the unit cell is present are the same.

In the electromagnetic wave control element 10 of the embodiment of the present invention, the material for forming the microstructure 14 constituting the metasurface structure 12 is not limited, and various materials used as the microstructure in a known metasurface structure can be used.

Examples of the material for forming the microstructure 14 include a metal and a dielectric. In a case of a metal, copper, gold, and silver are preferably exemplified from the viewpoint of low optical loss. In addition, as the material for forming the microstructure 14, a composite body consisting of metal particles and a binder, and an oxide semiconductor can also be used. On the other hand, in a case of a dielectric substance, silicon, titanium oxide, and germanium are preferably exemplified from the viewpoint that the refractive index is large and a large phase modulation is possible.

Furthermore, as shown in FIG. 1, in a case where the microstructure 14 also serves as an electrode forming an electrode pair together with the first electrode layer 26, the microstructure 14 is formed of a conductor.

Similarly, the shape of the microstructure 14 constituting the metasurface structure 12 is not also limited and various shapes that can be used as a microstructure in known metasurface structures can be used.

Examples of the shape include a cross-like three-dimensional structure in which cuboids intersect with each other, a cuboid shape, a cylindrical shape, a V-like three-dimensional structure in which cuboids are connected to end parts as described in JP2018-046395A, an H-like three-dimensional structure such as H-steel, and a substantially C-like three-dimensional structure such as a C-channel.

In addition, as the V-like three-dimensional structure as shown in JP2018-046395A, and the cross-like three-dimensional structure, various shapes where an angle between two cuboids is adjusted can be used.

In addition to those, the three-dimensional structure having a bottom surface shape as shown in FIG. 5 of “Appl. Sci. 2018, 8 (9), 1689; https://doi.org/10.3390/app 8091,689”, or the like can also be used.

In the metasurface structure 12, such microstructures 14 may be used alone or in combination of a plurality of kinds thereof. In addition, the same microstructures 14 may be arranged in the same orientation as shown in FIG. 2 or in different orientations, or the microstructures arranged in the same orientation and the microstructures arranged in different orientations may be mixed.

However, in the electromagnetic wave control element of the embodiment of the present invention, it is preferable that only one kind of the microstructures 14 are used and all the microstructures 14 are arranged in the same orientation.

In the example shown in the drawing, in a preferred aspect, in the metasurface structure 12, the same microstructures 14 having the same structure are two-dimensionally arranged at regular intervals in the x direction and the y direction orthogonal to each other.

However, the present invention is not limited thereto, and a plurality of kinds of the microstructures may be used in combination as described above, and the arrangement interval and the arrangement of the microstructures 14 may also be different in the plane direction of the support body 16.

It should be noted that in consideration of the controllability of the reflection direction of electromagnetic waves in a case where a voltage is applied to the liquid crystal layer 20, it is preferable that the metasurface structure 12 is formed of the same microstructures 14. Furthermore, in the metasurface structure 12, it is more preferable that the same microstructures 14 are two-dimensionally arranged at regular intervals, and it is still more preferable that the same microstructures 14 are two-dimensionally arranged at regular intervals in the x direction and the y direction orthogonal to each other.

The liquid crystal layer 20 is a layer in which the liquid crystal compound LC is aligned in a predetermined state, and as described above, the alignment state of the liquid crystal compound LC changes by applying a voltage.

As described above, in the liquid crystal layer 20 in the example shown in the drawing, the liquid crystal compound LC is vertically aligned in a state where no voltage is applied. In a case where a voltage is applied to the liquid crystal layer 20, the liquid crystal compound LC is aligned to be tilted with respect to the thickness direction depending on the voltage, and reaches a horizontal alignment at the maximum.

Furthermore, in the present invention, the change in the alignment of the liquid crystal compound LC is not limited to a change from the vertical alignment to the horizontal alignment or vice versa, may be a change from a state of being tilted with respect to the thickness direction to the horizontal alignment or the vertical alignment, may be a change from the horizontal alignment or the vertical alignment to a state of being tilted with respect to the thickness direction, or may be a change in the angle from a state of being tilted with respect to the thickness direction to a state of being tilted with respect to the thickness direction.

In the present invention, the liquid crystal layer 20 may be formed on a surface of the alignment film which will be described later by a known method.

Here, in the electromagnetic wave control element 10 of the embodiment of the present invention, the liquid crystal layer 20 includes an azo compound.

In the electromagnetic wave control element 10 of the embodiment of the present invention, the liquid crystal layer 20 includes an azo compound, so that the responsiveness is improved, and the reflection direction of the incident electromagnetic waves having a frequency of 0.1 to 0.3 THz can thus be switched in a short time.

The points described above will be described below.

In the electromagnetic wave control element 10, the liquid crystal layer 20 is formed on the support body 24.

The support body 24 is basically the same as the above-described support body 16.

Here, the support body 24 on which the liquid crystal layer 20 is formed may further have an alignment film for aligning the liquid crystal compound LC in a predetermined state on a surface of the above-described support body 16 used as a main body, on which the liquid crystal layer 20 of the main body is formed.

As the alignment film, various known films can be used. Examples of the alignment film include a rubbing-treated film consisting of an organic compound such as a polymer, an obliquely vapor-deposited film with an inorganic compound, a film having a microgroove, and a film formed by lamination of Langmuir-Blodgett (LB) films formed with a Langmuir-Blodgett's method using an organic compound such as @-tricosanoic acid, dioctadecylmethylammonium chloride, and methyl stearate.

In addition, as the alignment film, a so-called photo-alignment film obtained by irradiating a photo-alignable material with polarized light or non-polarized light can be used.

These alignment films may be formed by a known method depending on the material for forming the main body.

The entire surface of the surface of the support body 24 forming the liquid crystal layer 20 on a side opposite to the liquid crystal layer 20 is covered with the first electrode layer 26.

The first electrode layer 26 is an electrode that changes the alignment of the liquid crystal compound LC in the liquid crystal layer 20, and also acts as a reflective layer that reflects electromagnetic waves having a frequency of 0.1 to 0.3 THz incident from the metasurface structure 12 side, as described above.

The first electrode layer 26 is not limited, and a sheet-like material consisting of various known materials can be used as long as it has sufficient conductivity and can reflect electromagnetic waves having a frequency of 0.1 to 0.3 THz.

Examples of the first electrode layer 26 include metal layers such as copper, aluminum, gold, and silver, inorganic conductive materials such as indium tin oxide (ITO), organic conductive materials such as polythiophene typified by poly(3,4-ethylenedioxythiophene) (PEDOT), and graphene. The inorganic conductive material, the organic conductive material, the graphene, and the like are transparent to visible light, but act as a reflective layer with respect to the electromagnetic waves having the frequency.

The thickness of the first electrode layer 26 is not limited, and the thickness with which electromagnetic waves as a target can be reflected with a required reflectivity may be appropriately set depending on the material for forming the first electrode layer 26.

As described above, the electromagnetic wave control element 10 of the embodiment of the present invention is a reflective type electromagnetic wave control element having the metasurface structure 12 and the liquid crystal layer 20.

In the electromagnetic wave control element 10, by supplying power to each microstructure 14 to change the alignment state of the liquid crystal compound LC in the corresponding region of the liquid crystal layer 20, regions having different refractive indices in the plane direction are formed, and the incident electromagnetic waves having a frequency of 0.1 to 0.3 THz are thus reflected in a desired direction.

In addition, the reflection direction of the incident electromagnetic waves can be switched by changing the power supplied to each microstructure 14, that is, the voltage applied to the liquid crystal layer 20.

Here, as described above, in the electromagnetic wave control element (beam steering element) using a metasurface structure in the related art and a liquid crystal layer as shown in Jingbo Wu et al., Liquid crystal programmable metasurface for terahertz beam steering, Applied Physics Letters, 116, 131104 (2020), the switching of the reflection direction of electromagnetic waves takes time.

On the other hand, in the electromagnetic wave control element 10 of the embodiment of the present invention, by including the azo compound contained in the liquid crystal layer 20, preferably by including the liquid crystal compound having an azo structure in the liquid crystal layer 20, and more preferably by forming the liquid crystal layer 20 with a liquid crystal compound having an azo structure, high responsiveness can be ensured, and the switching of the reflection direction of the incident electromagnetic waves can be performed in a short time.

That is, in the present invention, by including an azo compound in the liquid crystal layer 20, Δn (secondary refraction) of the liquid crystal layer can be increased. Therefore, in the present invention, the thickness of the liquid crystal layer required for providing the electromagnetic wave with a required refractive index, that is, a required phase difference can be reduced. In a case where the thickness of the liquid crystal layer is reduced, the alignment of the liquid crystal compound LC rapidly changes in a case where the applied voltage is changed.

As a result, with the electromagnetic wave control element 10 of the embodiment of the present invention, it is possible to increase the response speed to the change in the voltage applied to the liquid crystal layer 20 and to switch the reflection direction of the incident electromagnetic wave in a short time.

The azo compound is not particularly limited as long as it is a compound including an azo structure (—N═N—).

The number of azo structures contained in the azo compound is not particularly limited, may be 1 or more, and is preferably 2 or more. The upper limit of the number of azo structures is not particularly limited, but is often 5 or less and more often 3 or less.

The azo compound may be a compound exhibiting liquid crystallinity or a compound not exhibiting liquid crystallinity, and is preferably the compound exhibiting liquid crystallinity. That is, the azo compound is preferably a liquid crystal compound having an azo structure.

As the azo compound, a compound represented by Formula (1) is preferable.

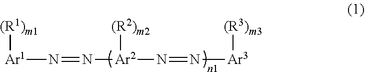

In Formula (1), Ar¹ represents an (m1+1)-valent aromatic ring.

The (m1+1)-valent aromatic ring may be a monocyclic ring or a fused ring of two or more rings. Alternatively, the aromatic ring may be a ring in which a plurality of monocyclic rings are bonded through a single bond (for example, a biphenyl ring or a terphenyl ring).

Examples of the (m1+1)-valent aromatic ring include an aromatic hydrocarbon ring or an aromatic heterocyclic ring.

Examples of the aromatic hydrocarbon ring include a benzene ring, a naphthalene ring, an azulene ring, a fluorene ring, a biphenyl ring, and an anthracene ring. Among these, the benzene ring is preferable.

Examples of the aromatic heterocyclic ring include a pyridine ring, a thiophene ring, a furan ring, a quinoline ring, an isoquinoline ring, a thiazole ring, a thienothiophene ring, and a thienothiazole ring.

For example, in a case where m1 is 1, Ar¹ represents a divalent aromatic ring.

In Formula (1), Ar² represents an (m2+2)-valent aromatic ring.

The (m2+1)-valent aromatic ring may be a monocyclic ring or a fused ring of two or more rings. Alternatively, the aromatic ring may be a ring in which a plurality of monocyclic rings are bonded through a single bond (for example, a biphenyl ring or a terphenyl ring).

Examples of the (m2+1)-valent aromatic ring include an aromatic hydrocarbon ring or an aromatic heterocyclic ring.

Examples of the aromatic hydrocarbon ring include a benzene ring, a naphthalene ring, an azulene ring, a fluorene ring, a biphenyl ring, and an anthracene ring. Among these, the benzene ring is preferable.

Examples of the aromatic heterocyclic ring include a pyridine ring, a thiophene ring, a furan ring, a quinoline ring, an isoquinoline ring, a thiazole ring, a thienothiophene ring, and a thienothiazole ring.

For example, in a case where m2 is 1, Ar² represents a trivalent aromatic ring.

In Formula (1), Ar³ represents an (m3+1)-valent aromatic ring.

The (m3+1)-valent aromatic ring may be a monocyclic ring or a fused ring of two or more rings. Alternatively, the aromatic ring may be a ring in which a plurality of monocyclic rings are bonded through a single bond (for example, a biphenyl ring or a terphenyl ring).

Examples of the (m3+1)-valent aromatic ring include an aromatic hydrocarbon ring or an aromatic heterocyclic ring.

Examples of the aromatic hydrocarbon ring include a benzene ring, a naphthalene ring, an azulene ring, a fluorene ring, a biphenyl ring, and an anthracene ring. Among these, the benzene ring is preferable.

Examples of the aromatic heterocyclic ring include a pyridine ring, a thiophene ring, a furan ring, a quinoline ring, an isoquinoline ring, a thiazole ring, a thienothiophene ring, and a thienothiazole ring.

For example, in a case where m3 is 1, Ar³ represents a divalent aromatic ring.

In Formula (1), R¹, R², and R³ each independently represent a substituent.

In a case of m1≥2, a plurality of R¹'s may be the same as or different from each other, in a case of m2≥2, a plurality of R²'s may be the same as or different from each other, and in a case of m3≥2, a plurality of R³'s may be the same as or different from each other.

The substituent is a monovalent substituent, and examples thereof include an alkyl group, an alkenyl group, an aralkyl group, an aryl group, a heterocyclic group, a halogen atom, a cyano group, a nitro group, a mercapto group, a hydroxy group, an alkoxy group, an aryloxy group, an alkylthio group, an arylthio group, an acyloxy group, an amino group, an alkylamino group, a dialkylamino group, a carbonamide group, a sulfonamide group, a sulfamoylamino group, an oxycarbonylamino group, an oxysulfonylamino group, a ureido group, a thioureido group, an acyl group, an oxycarbonyl group, a carbamoyl group, a sulfonyl group, a sulfinyl group, a sulfamoyl group, a carboxy group (including a salt), a sulfo group (including a salt), and a group obtained by combining these groups. These groups may be further substituted with these groups.

In Formula (1), m1, m2, and m3 each independently represent an integer of 0 to 5. m1 is preferably 1 to 3, m2 is preferably 0 to 1, and m3 is preferably 1 to 3.

In Formula (1), n1 represents an integer of 1 to 4, and is preferably 1 to 3, and more preferably 2 or 3.

In the electromagnetic wave control element 10 of the embodiment of the present invention, Δn of the liquid crystal layer 20 is not limited, but it is preferable that Δn is large.

Here, in the reflective type electromagnetic wave control element 10 as in the example shown in the drawing, Δn of the liquid crystal layer 20 is preferably 0.35 or more.

It is preferable that Δn of the liquid crystal layer 20 is set to 0.35 or more from the viewpoint that, for example, the liquid crystal layer 20 can be made thin and the switching of the reflection direction of electromagnetic waves can be more quickly performed.

In addition, the thickness of the liquid crystal layer 20 is not limited, and the thickness for imparting a phase difference required for electromagnetic waves may be appropriately set depending on the material for forming the liquid crystal layer 20.

Here, as described above, in the electromagnetic wave control element 10 of the embodiment of the present invention, since the liquid crystal layer 20 contains an azo compound, the liquid crystal layer 20 can be made thin. In consideration of this point, the thickness of the liquid crystal layer 20 is preferably 200 μm or less, more preferably 150 μm or less, and still more preferably 100 μm or less.

It is preferable to set the thickness of the liquid crystal layer 20 to 200 μm or less from the viewpoint that the switching of the reflection direction of electromagnetic waves can be performed more quickly.

In the electromagnetic wave control element of the embodiment of the present invention, the reflective type electromagnetic wave control element is not limited to the configuration shown in FIG. 1, and various configurations can be exemplified.

For example, in the electromagnetic wave control element 10 shown in FIG. 1, the microstructure 14 constituting the metasurface structure 12 also acts as an electrode. However, the present invention is not limited thereto, and the second electrode 30 constituting an electrode pair together with the first electrode layer 26 may be provided, corresponding to the microstructure 14. The second electrode 30 may be formed of the same material as the first electrode layer 26.

Furthermore, in the examples shown below, although not shown, the power supply 28 is connected to each electrode or the microstructure 14 that also serves as an electrode, in the same manner as in the example shown in FIG. 1.

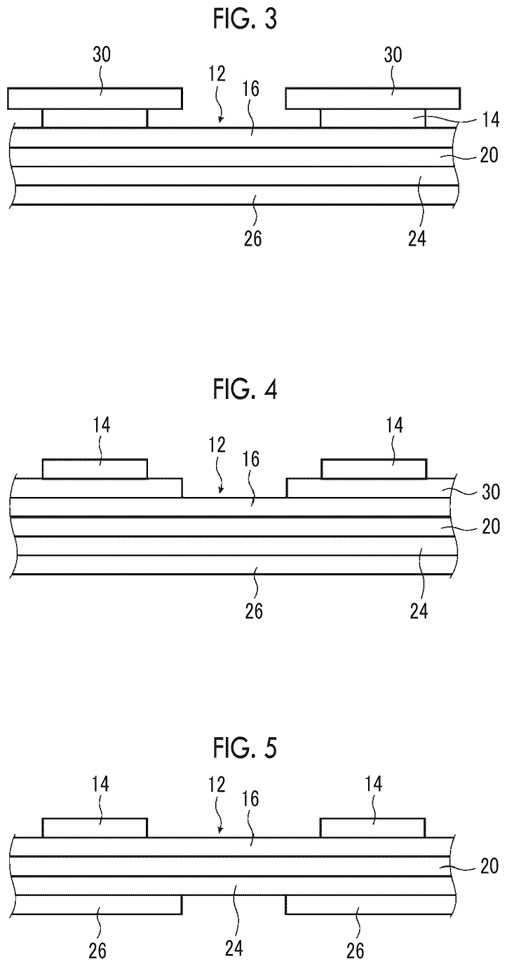

As this configuration, for example, a configuration in which the second electrode 30 is provided on the microstructure 14, as conceptually shown in FIG. 3, is exemplified.

Alternatively, the second electrode 30 may be provided between the microstructure 14 and the support body 16, as conceptually shown in FIG. 4.

Furthermore, a configuration in which the first electrode layer 26 in the configuration shown in FIG. 1 is patterned to form a patterned electrode and the patterned electrode is provided only in a region corresponding to the microstructure 14, as conceptually shown in FIG. 5, can also be used. In this configuration, the electromagnetic waves incident on the region where the first electrode layer 26 is not provided are transmitted.

In addition, in the electromagnetic wave control element of the embodiment of the present invention, in the reflective type electromagnetic wave control element, the microstructure 14 may be provided to be adjacent to the liquid crystal layer 20, and the metasurface structure 12 may be provided between the layer-like electrodes.

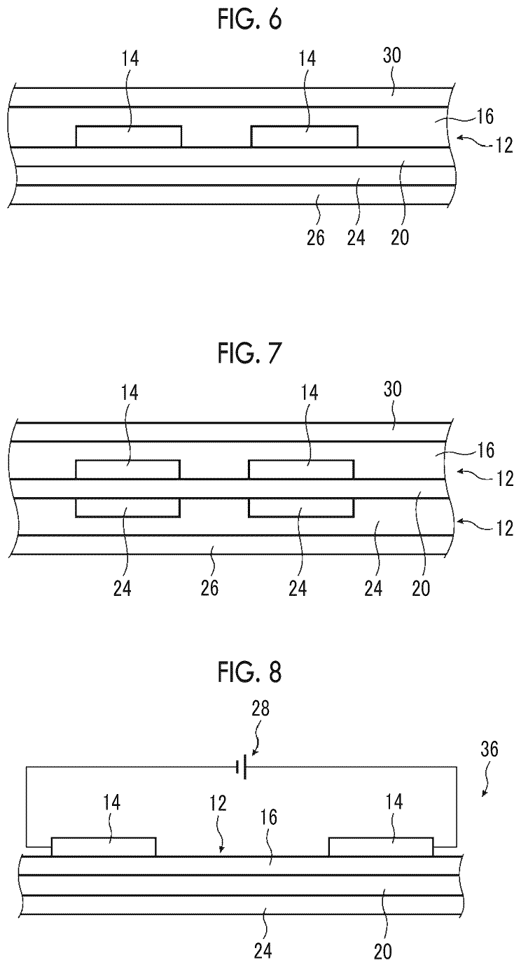

For example, the microstructure 14 may be provided on the liquid crystal layer 20 side of the support body 16, and the second electrode 30 having a layered (planar) shape may be provided on a side of the support body 16 opposite to the liquid crystal layer 20, as conceptually shown in FIG. 6. In this configuration, the second electrode 30 is patterned to have a plurality of opening portions to form a patterned electrode, and the second electrode 30 can transmit electromagnetic waves.

In this configuration, the microstructures 14 may be arranged on the support body 24 and the metasurface structure 12 may be provided on both surfaces of the liquid crystal layer 20, as conceptually shown in FIG. 7.

The electromagnetic wave control element of the embodiment of the present invention described above is a reflective type electromagnetic wave control element that reflects incident electromagnetic waves having a frequency of 0.1 to 0.3 THz to travel in a desired direction, but the present invention is not limited thereto.

That is, the electromagnetic wave control element of the embodiment of the present invention may be a transmissive type electromagnetic wave control element that refracts and transmits incident electromagnetic waves having a frequency of 0.1 to 0.3 THz to travel in a desired direction.

In the following description, unless otherwise specified, the electromagnetic waves refer to electromagnetic waves having a frequency of 0.1 to 0.3 THz.

FIG. 8 conceptually shows an example of a transmissive type electromagnetic wave control element.

Furthermore, the transmissive type electromagnetic wave control element of the embodiment of the present invention described below is basically the same as the above-described reflective type electromagnetic wave control element, except that the first electrode layer 26, serving as a reflective layer, is not provided, and the actions of the respective members are also the same.

Accordingly, the same members are denoted by the same reference numerals and different parts will be mainly described.

A transmissive type electromagnetic wave control element 36 shown in FIG. 8 has the same configuration as the reflective type electromagnetic wave control element 10 shown in FIG. 1, except that the first electrode layer 26 is not provided.

That is, the electromagnetic wave control element 36 has the metasurface structure 12 and the liquid crystal layer 20. The metasurface structure 12 is formed by two-dimensionally arranging the microstructures 14 serving as resonators on the support body 16, and the liquid crystal layer 20 is formed on the support body 24.

Here, in the electromagnetic wave control element 36 shown in FIG. 8, the microstructure 14 serves as both the first electrode and the second electrode. That is, in the electromagnetic wave control element 36, the adjacent microstructures 14 are connected to each other, and thus, the power supply 28 is provided.

In the electromagnetic wave control element 36, power is supplied from the power supply 28 to the microstructure 14 to apply a voltage in the plane direction to the liquid crystal layer 20 between the adjacent microstructures 14.

As a result, the alignment state of the liquid crystal compound LC in the liquid crystal layer 20 in this region changes depending on the applied voltage, and the refractive index changes. In addition, by changing the power supplied to each microstructure 14, that is, the voltage applied to the corresponding region, regions having different refractive indices in the plane direction can be formed.

In the same manner as in the electromagnetic wave control element 10, in a case where electromagnetic waves are incident on the electromagnetic wave control element 36, the phase of the electromagnetic waves is modulated by resonance of the microstructure 14 (unit cell) in a case of transmitting through the metasurface structure 12, and further modulated by being transmitted through the liquid crystal layer 20.

Since the electromagnetic wave control element 36 does not have the first electrode layer 26 serving as a reflective layer, the electromagnetic waves are transmitted through the liquid crystal layer 20 and is emitted from the electromagnetic wave control element 36 as transmitted electromagnetic waves.

Here, as described above, since the liquid crystal layer 20 has different refractive indices in the plane direction, the phase difference applied to the electromagnetic wave transmitted through the liquid crystal layer 20 differs depending on each region in the plane direction. Therefore, the electromagnetic waves have different apparent optical path lengths depending on the phase difference given depending on the incidence region, and the electromagnetic waves transmitted through the region having a longer optical path length are emitted from the liquid crystal layer 20 more slowly than the electromagnetic waves transmitted through the region having a shorter optical path length.

As a result, the electromagnetic waves incident on and transmitted through the electromagnetic wave control element 36 are not transmitted linearly, but are refracted and transmitted to align the wavefront. For example, the electromagnetic wave incident from the normal direction is not transmitted in the normal direction, but is transmitted in a direction tilted with respect to the normal direction.

In addition, the refractive index of the transmitted electromagnetic wave, that is, the emission direction of the electromagnetic waves can be switched by changing the power supplied to each microstructure 14, that is, the voltage applied to the liquid crystal layer 20.

Furthermore, by adjusting the voltage applied to the liquid crystal layer 20, the transmitted electromagnetic waves may be focused or diffused, and the focus and the degree of diffusion of the transmitted electromagnetic waves may be switched.

Here, also in the electromagnetic wave control element 36, since the liquid crystal layer 20 includes the azo compound, the refractive index, that is, the refraction direction (traveling direction) of transmitted light can be quickly switched.

In the transmissive type electromagnetic wave control element 36 of the embodiment of the present invention, Δn of the liquid crystal layer 20 is not limited, but it is preferable that Δn is large.

Here, in the electromagnetic wave control element 36 having a transmissive type as in the example shown in the drawing, Δn of the liquid crystal layer 20 is preferably 0.2 or more, more preferably 0.3 or more, and still more preferably 0.4 or more.

In the electromagnetic wave control element 36, it is preferable that Δn of the liquid crystal layer 20 is set to 0.2 or more from the viewpoint that, for example, the liquid crystal layer 20 can be made thin and the switching of the reflection direction of electromagnetic waves can be performed more quickly.

In addition, the thickness of the liquid crystal layer 20 is not limited, and the thickness for imparting a phase difference required for electromagnetic waves may be appropriately set depending on the material for forming the liquid crystal layer 20.

Here, as described above, also in the transmissive type electromagnetic wave control element 36, since the liquid crystal layer 20 includes the azo compound, the liquid crystal layer 20 can be made thin. In addition, in the present invention, the target electromagnetic waves are electromagnetic waves having a frequency of 0.1 to 0.3 THz, that is, electromagnetic waves having a wavelength of 1 to 3 mm.

In consideration of this point, the thickness of the liquid crystal layer 20 in the transmissive type electromagnetic wave control element 36 is preferably 500 μm or less, more preferably 300 μm or less, and still more preferably 200 μm or less.

It is preferable to set the thickness of the liquid crystal layer 20 to 500 μm or less from the viewpoint that the switching of the reflection direction of electromagnetic waves can be more quickly performed.

In the electromagnetic wave control element of the embodiment of the present invention, the transmissive type electromagnetic wave control element is not limited to the electromagnetic wave control element 36 shown in FIG. 8, and various configurations can be exemplified. Furthermore, in the examples shown below, although not shown, the power supply 28 is connected to each electrode or the microstructure 14 that also serves as an electrode, in the same manner as in the example shown in FIG. 8.

For example, in the electromagnetic wave control element 36 shown in FIG. 8, the microstructure 14 constituting the metasurface structure 12 also acted as an electrode. However, the present invention is not limited thereto, and the first electrode 32 and the second electrode 30 may be provided corresponding to the microstructure 14.

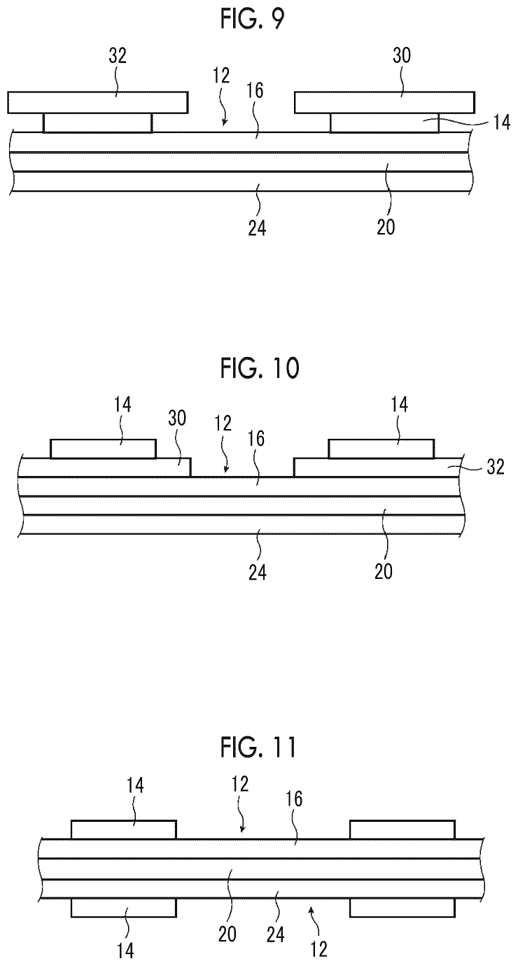

Examples of this configuration include a configuration in which the first electrode 32 is provided on one of two adjacent microstructures 14, and the second electrode 30 is provided on the other microstructure 14, as conceptually shown in FIG. 9.

Alternatively, in the two adjacent microstructures 14, the first electrode 32 may be provided between one microstructure 14 and the support body 16, and the second electrode 30 may be provided between the other microstructure 14 and the support body 16, as conceptually shown in FIG. 10.

The transmissive type electromagnetic wave control element may have a plurality of metasurface structures.

For example, as shown in FIG. 11, in the electromagnetic wave control element 36 shown in FIG. 8, the microstructures 14 may be arranged on a surface of the support body 24 opposite to the liquid crystal layer 20 to form the metasurface structure 12. In the present example, as an example, the microstructures 14 facing each other with the liquid crystal layer 20 interposed therebetween act as an electrode pair, that is, the first electrode and the second electrode.

Also in the configuration shown in FIG. 11, the first electrode 32 and the second electrode 30 may be provided corresponding to the microstructure 14.

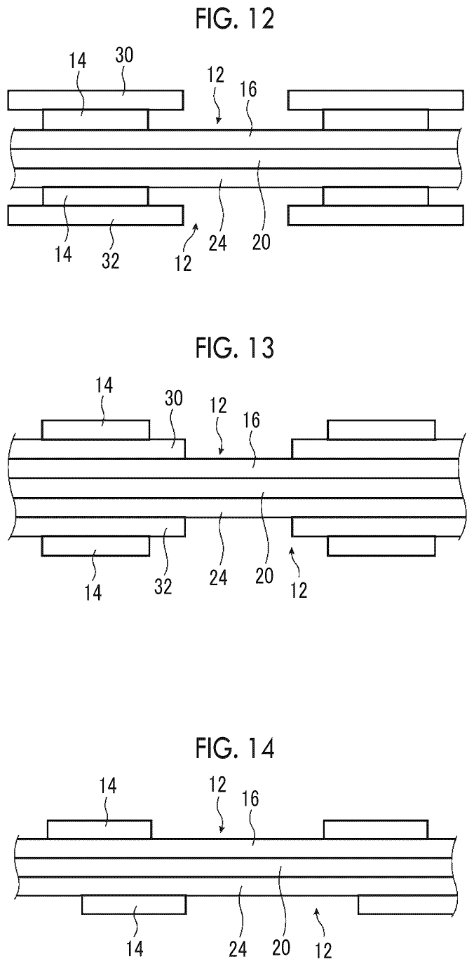

Examples of this configuration include a configuration in which the first electrode 32 is provided on a surface of one microstructure 14, and the second electrode 30 is provided on a surface of the other microstructure 14 in the two microstructures 14 facing each other, constituting an electrode pair, with the liquid crystal layer 20 interposed therebetween, as conceptually shown in FIG. 12.

Alternatively, in the two microstructures 14 facing each other, constituting the electrode pair, with the liquid crystal layer 20 interposed therebetween, the first electrode 32 may be provided between one microstructure 14 and the support body 16, and the second electrode 30 may be provided between the other microstructure 14 and the support body 16, as conceptually shown in FIG. 13.

In the transmissive type electromagnetic wave control element having a plurality of metasurface structures, the microstructures 14 constituting the metasurface structure 12 may be disposed to be shifted in the plane direction, as conceptually shown in FIG. 14. Also in this configuration, as an example, the microstructures 14 facing each other with the liquid crystal layer 20 interposed therebetween act as an electrode pair, that is, the first electrode and the second electrode, as in the example shown in FIG. 11.

In addition, also in the configuration shown in FIG. 14, the first electrode 32 and the second electrode 30 may be provided corresponding to the microstructure 14.

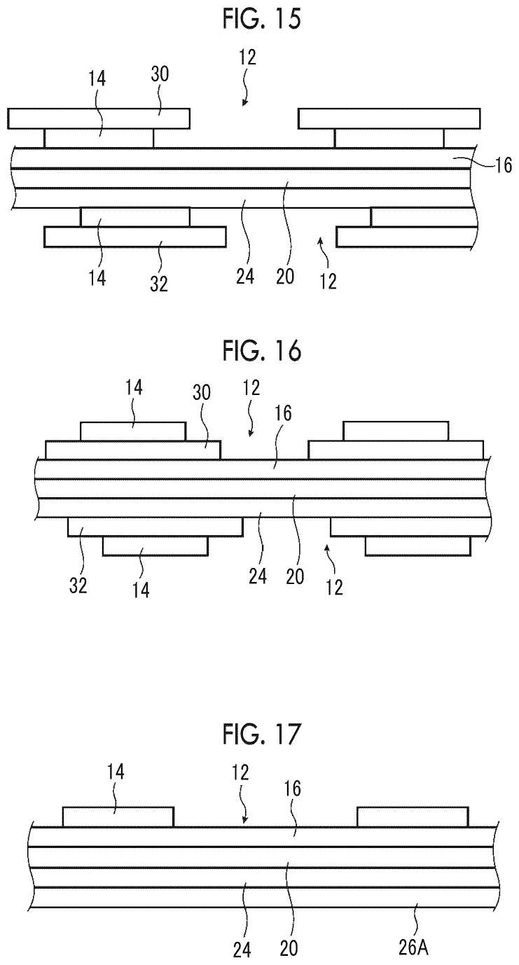

Examples of this configuration include a configuration in which the first electrode 32 is provided on a surface of one microstructure 14, and the second electrode 30 is provided on a surface of the other microstructure 14 in the two microstructures 14 facing each other, constituting an electrode pair, with the liquid crystal layer 20 interposed therebetween, as conceptually shown in FIG. 15.

Alternatively, in the two microstructures 14 constituting the electrode pair facing each other, constituting an electrode pair, with the liquid crystal layer 20 interposed therebetween, the first electrode 32 may be provided between one microstructure 14 and the support body 16, and the second electrode 30 may be provided between the other microstructure 14 and the support body 16, as conceptually shown in FIG. 16.

Furthermore, as conceptually shown in FIG. 17, also in the transmissive type electromagnetic wave control element, the first electrode layer 26A may be provided to entirely cover the support body 24 on the side opposite to the liquid crystal layer 20, and the microstructure 14 and the first electrode layer 26A may constitute an electrode pair, as in the above-described reflective type electromagnetic wave control element. It should be noted that in this case, the first electrode layer 26A is a patterned electrode that was patterned to have a plurality of opening portions, and is allowed to transmit electromagnetic waves.

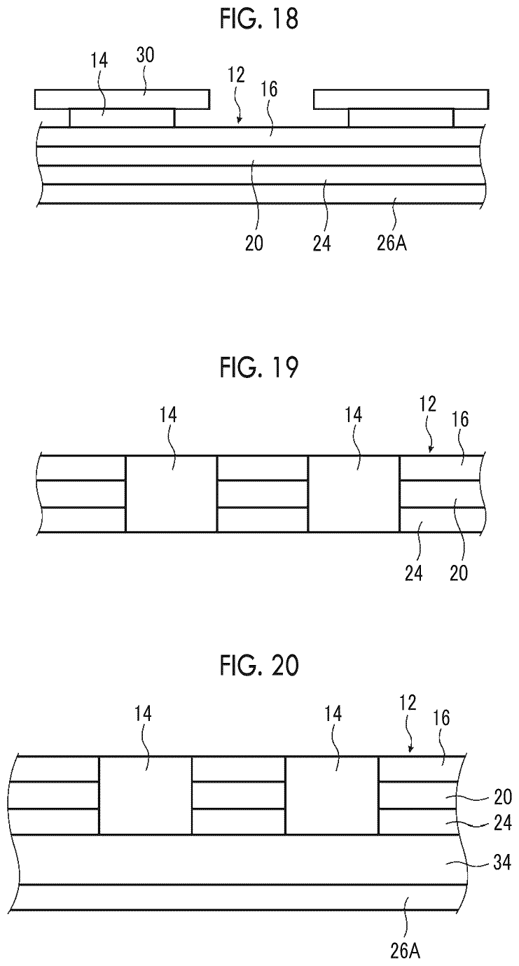

Furthermore, also in a configuration having the first electrode layer 26A as shown in FIG. 17, the microstructure 14 may not be used as the electrode layer, and as conceptually shown in FIG. 18, the second electrode 30 may be provided on the microstructure 14 to form an electrode pair of the first electrode layer 26A and the second electrode 30.

Furthermore, in the transmissive type electromagnetic wave control element, the microstructures 14 are not arranged on the surface of the support body, and as conceptually shown in FIG. 19, the microstructure 14 may be provided to penetrate the electromagnetic wave control element in the thickness direction. Furthermore, also in this configuration, the microstructure 14 may serve as an electrode, or the first electrode and/or the second electrode may be disposed corresponding to each microstructure 14, as in each of the above-described examples.

Alternatively, in the configuration shown in FIG. 19, the dielectric layer 34 may be provided on a side of the support body 24 opposite to the liquid crystal layer 20, and the first electrode layer 26A which is patterned to have a plurality of opening portions through which electromagnetic waves are transmitted may be provided on a side of the dielectric layer 34 opposite to the support body 24, as shown in FIG. 20.

Here, in the above-described example, the electromagnetic wave control element reflects electromagnetic waves and controls a reflection direction of the electromagnetic waves. However, the electromagnetic wave control element of the embodiment of the present invention is not limited thereto.

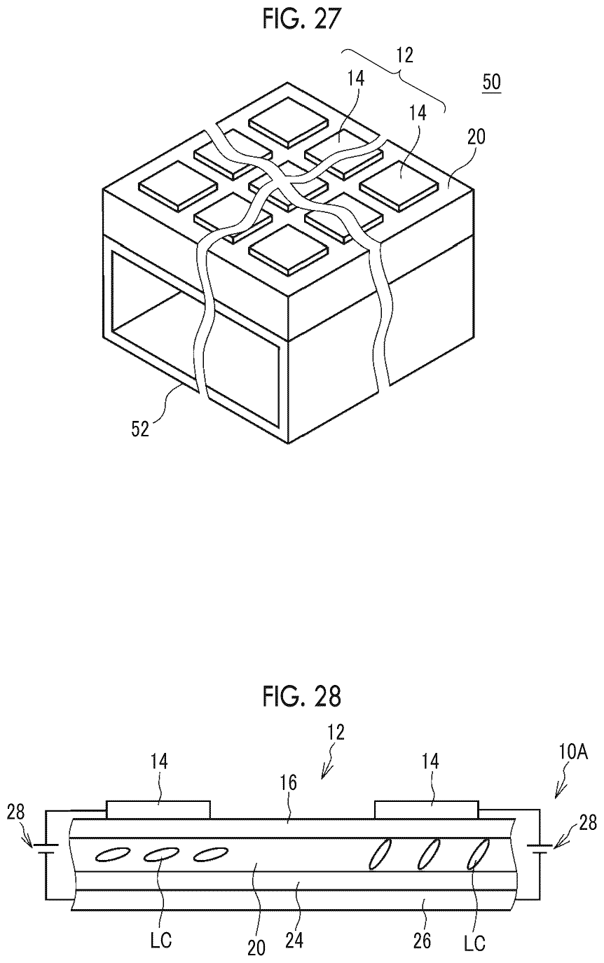

FIG. 26 is a view conceptually showing another example of the electromagnetic wave control element of the embodiment of the present invention. In addition, FIG. 27 is a schematic perspective view of the electromagnetic wave control element shown in FIG. 26.

The electromagnetic wave control element 50 shown in FIGS. 26 and 27 includes a waveguide 52, a liquid crystal layer 20, and a metasurface structure 12 (microstructure 14) in this order from the bottom in the drawing. The liquid crystal layer 20 is provided on a part of an outer side surface of the waveguide 52. In the electromagnetic wave control element 50 shown in FIGS. 26 and 27, the waveguide 52 is a waveguide tube consisting of a conductor such as a metal, and the waveguide 52 also serves as the first electrode (first electrode layer) in the present invention.

Furthermore, in the electromagnetic wave control element 50 shown in FIGS. 26 and 27, the same parts as those of the electromagnetic wave control element 10 shown in FIG. 1 are denoted by the same reference numerals, and the following description will be mainly made for different parts.

In addition, the electromagnetic wave control element 50 shown in FIGS. 26 and 27 does not have the support body 16 and the support body 24, but in the present example, the support body 16 and/or the support body 24 may be provided as necessary.

In the electromagnetic wave control element 50 shown in FIGS. 26 and 27, the waveguide 52 is a tubular member having a rectangular cross section, and is a metal-made waveguide tube that guides the electromagnetic waves RW within the hollow portion.

The electromagnetic waves RW propagate through the waveguide 52 while forming an electromagnetic field depending on the shape and the dimensions of the waveguide 52, the wavelength (frequency) of the electromagnetic waves RW, and the like.

In addition, the waveguide 52 has a plurality of openings 54 that communicate the hollow portion with the outside in a wall portion on a side on which the liquid crystal layer 20 and the microstructure 14 are laminated, that is, a surface that faces the microstructure 14 and acts as the first electrode.

Each of the openings 54 is provided at a position corresponding to the unit cell (that is, the microstructure 14).

In a case where the waveguide 52 has a plurality of openings 54, the electromagnetic waves RW guided within the hollow portion of the waveguide 52 leak out from the openings 54 and are released to the outside. In this case, the electromagnetic waves RW pass through the liquid crystal layer 20.

Also in the electromagnetic wave control element 50, the traveling direction of the electromagnetic waves RW can be controlled by performing phase modulation, that is, controlling the amount of delay of the phase for each unit cell, in the same manner as in the electromagnetic wave control element 10 shown in FIG. 1. That is, the electromagnetic wave control element 50 can control the emission direction of the electromagnetic waves RW. In addition, by actively changing the delay amount of the phase in each unit cell, it is possible to actively change the emission direction of the electromagnetic waves RW.

Furthermore, in the examples shown in FIGS. 26 and 27, the cross-sectional shape of the waveguide 52 is a rectangular shape, but the present invention is not limited thereto, and various shapes such as a square shape, a circular shape, and a polygonal shape can be adopted.

Moreover, the dimensions of the waveguide 52 are not particularly limited.

In addition, the length of the waveguide 52 is preferably 1 to 10,000 mm, and more preferably 3 to 3,000 mm.

Moreover, as in the examples shown in FIGS. 26 and 27, in a case where the waveguide 52 also serves as the first electrode, the waveguide 52 can be formed of the same material (conductor) as the above-described material for forming the first electrode.

In addition, in the examples shown in FIGS. 26 and 27, the waveguide 52 also serves as the first electrode, but the present invention is not limited thereto, and the waveguide and the first electrode may be separate bodies.

In a case where the waveguide 52 and the first electrode are separate bodies, the waveguide 52 is disposed on a surface of the first electrode opposite to the liquid crystal layer 20. Also in a case where the waveguide and the first electrode are separate bodies, the first electrode has an opening through which the electromagnetic waves RW pass at a position corresponding to each cell unit. In addition, the waveguide is provided with an emission unit that emits the electromagnetic waves RW at a position corresponding to the opening of the first electrode.

In a case where the waveguide and the first electrode are separate bodies, in addition to the waveguide tube formed of the above-described conductor, a waveguide capable of guiding electromagnetic waves, such as a strip line, a microstrip line, and a coplanar line, which are known in the related art, can be appropriately used as the waveguide.

In addition, the size of the opening formed in the first electrode is preferably 0.01 to 100,000 mm², more preferably 0.02 to 80,000 mm², and still more preferably 0.05 to 50,000 mm².

In addition, in the example shown in the drawing, the opening formed in the first electrode is configured to be provided in each unit cell, but the present invention is not limited thereto, and two or more openings may be provided in each unit cell.

In the example above, the alignment pattern of the liquid crystal compound LC in the liquid crystal layer 20 is a liquid crystal alignment pattern in which the liquid crystal compound LC is vertically aligned in a state where no voltage is applied, the angle with respect to the thickness direction increases in response to an applied voltage in a case where the voltage is applied, and finally, the liquid crystal compound LC is horizontally aligned.

However, the present invention is not limited thereto and various liquid crystal alignment patterns can be used. An example thereof will be shown below.

Furthermore, in the examples shown below, as in FIG. 2, only the liquid crystal layer 20, the microstructure 14, and the first electrode layer 26 are shown for simplicity of action.

In addition, in the examples shown below, as an example, the microstructure 14 and the first electrode layer 26 are exemplified as the electrodes, but the present invention is not limited thereto and the liquid crystal alignment pattern shown below can be used in all the configurations shown in FIGS. 1 and 3 to 20. In this regard, the same applies to FIG. 2.

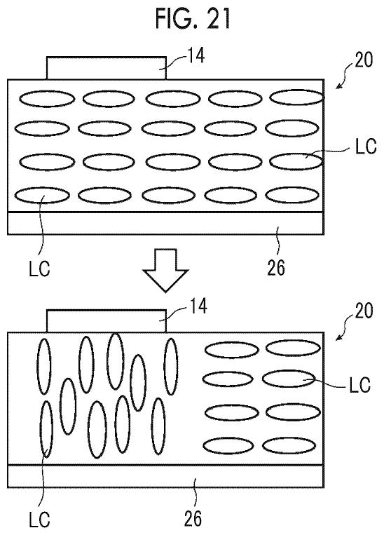

In the electromagnetic wave control element of the embodiment of the present invention, a liquid crystal alignment pattern in which the liquid crystal compound LC is horizontally aligned in a state where no voltage is applied, the angle with respect to the main surface of the liquid crystal layer 20 increases in response to the applied voltage in a case where the voltage is applied, and finally, the liquid crystal compound LC is vertically aligned, as conceptually shown in FIG. 21, can also be used as the liquid crystal alignment pattern of the liquid crystal layer 20.

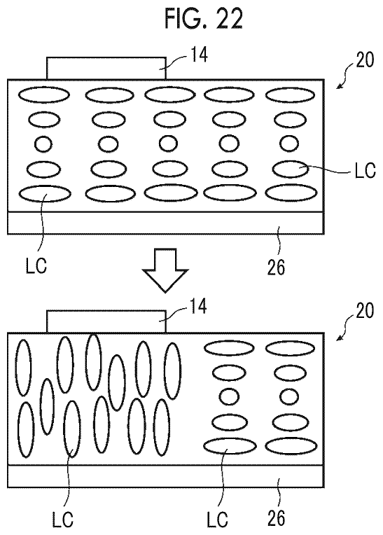

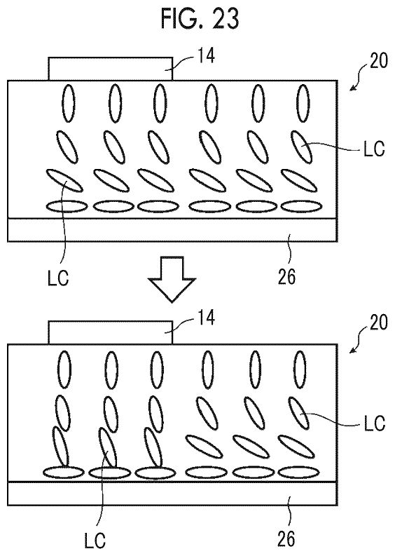

In addition, a liquid crystal alignment pattern in which the liquid crystal compound LC is horizontally aligned, and helically twisted and aligned in the thickness direction in a state where no voltage is applied, the angle with respect to the main surface of the liquid crystal layer 20 increases in response to an applied voltage in a case where the voltage is applied, and finally, the liquid crystal compound LC is vertically aligned, as conceptually shown in FIG. 22, can also be used as the liquid crystal alignment pattern of the liquid crystal layer 20.

Furthermore, a hybrid alignment in which the alignment of the liquid crystal compound LC changes from horizontal alignment to vertical alignment in the thickness direction, as conceptually shown in FIG. 23, can also be used as the liquid crystal alignment pattern of the liquid crystal layer 20. In this liquid crystal alignment pattern, as an example, in a state case where a voltage is applied from a state where no voltage is applied, as shown in FIG. 23, a configuration in which the alignment of the liquid crystal compound LC is closer to the vertical alignment in response to the applied voltage is exemplified.

In addition, in the electromagnetic wave control element of the embodiment of the present invention, a voltage may be applied in the plane direction of the liquid crystal layer 20, as shown in FIGS. 8 to 10.

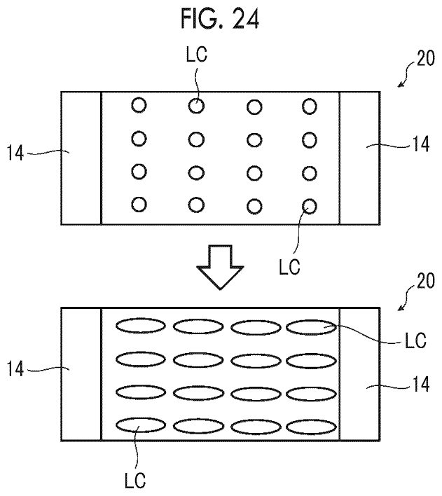

In this configuration, as conceptually shown in FIG. 24, a liquid crystal alignment pattern, in which in a state where no voltage is applied, the liquid crystal compound LC is horizontally aligned with the longitudinal direction coinciding with a direction perpendicular to the paper surface, and in a case where a voltage is applied, the liquid crystal compound LC rotates in the plane direction in response to the applied voltage, and is finally horizontally aligned with the longitudinal direction coinciding with the lateral direction in the drawing, can also be used.

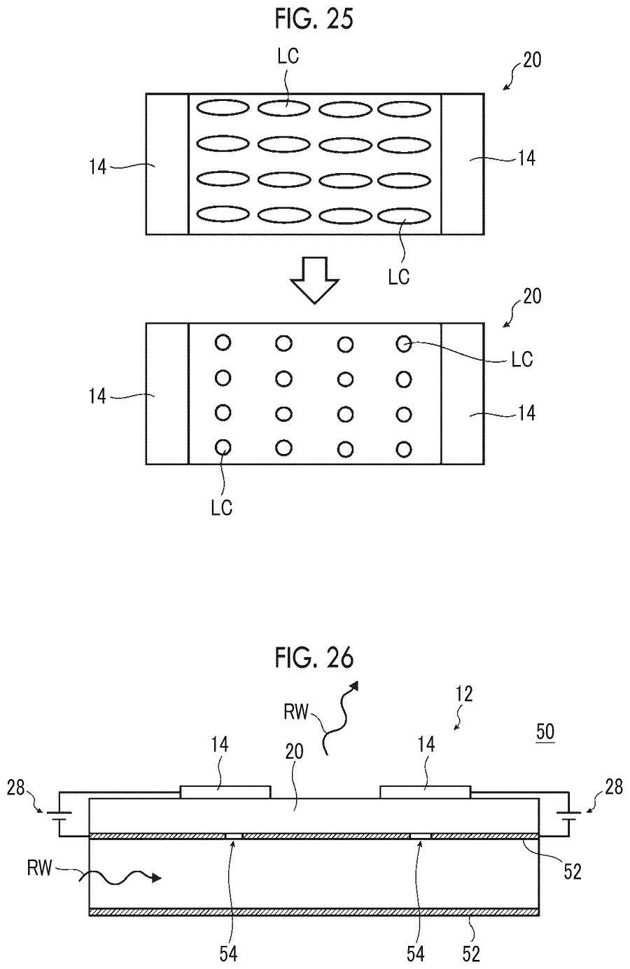

Alternatively, conversely, as conceptually shown in FIG. 25, in a state where no voltage is applied, the liquid crystal compound LC is horizontally aligned with the longitudinal direction coinciding with the transverse direction in the drawing, and it is also possible to use a liquid crystal alignment pattern in which in a case where a voltage is applied, the liquid crystal compound LC rotates in the plane direction in response to the applied voltage, and is finally horizontally aligned with the longitudinal direction coinciding with a direction perpendicular to the paper surface.

The polarized light state (polarized wave state) of the electromagnetic waves, which are targeted by the electromagnetic wave control element of the embodiment of the present invention, is not limited, and may be unpolarized light, linearly polarized light, circularly polarized light, or elliptically polarized light.

Furthermore, in a case where the electromagnetic waves are linearly polarized light and the microstructures 14 are two-dimensionally arranged in the x direction and the y direction orthogonal to each other, it is preferable that the electromagnetic waves are incident such that the polarization direction of the electromagnetic waves coincides with the x direction or the y direction.

Hereinbefore, the electromagnetic wave control element of the embodiment of the present invention has been described in detail, but the present invention is not limited to the above-described examples, and various improvements and changes can be made without departing from the spirit of the present invention.

### EXAMPLES

Hereinafter, the present invention will be described in more detail with reference to Examples.

The materials, the amounts of materials used, the ratios, the treatment details, the treatment procedure, or the like shown in the following Examples can be appropriately modified without departing from the spirit of the present invention. Therefore, the scope of the present invention should not be restrictively interpreted by the following Examples.

### EXAMPLE

Using optical simulation software, a model of the electromagnetic wave control element (model 10A of the electromagnetic wave control element) as shown in FIG. 28 was manufactured. For the simulation, finite element method simulation software “COMSOL Multiphysics” manufactured by COMSOL, Inc. was used.

The electromagnetic wave control element to be modeled had a structure in which the first electrode layer 26, the liquid crystal layer 20, and the microstructure 14 (metasurface structure 12) were laminated in this order. In addition, the size of one unit cell was set to 1.1 mm×1.1 mm, and a configuration in which unit cells were infinitely arranged in the in-plane direction was adopted by applying periodic boundary conditions.

The first electrode layer 26 and the microstructure 14 were made of copper as a material and had a thickness set to 2 μm. In addition, the size of one microstructure 14 was set to a square shape of 0.8 mm×0.8 mm, and the microstructure 14 was disposed at a substantially center position of the unit cell in the in-plane direction.

The liquid crystal layer 20 was formed of a liquid crystal composition obtained by mixing the following compound 1 (liquid crystal compound 1) and the following compound 2 (liquid crystal compound 2) at a ratio of 50%: 50%.

Here, Δn of the liquid crystal composition of Examples was measured by the following method.

First, a glass cell (10 mm×10 mm, thickness: 1.0 mm) in which a tin oxide (SnO₂) film was formed as an electrode by a sputtering method was sealed with a liquid crystal composition, then an optical system for transmissive type terahertz spectroscopy was manufactured, and a time waveform of the photoelectric field was measured in an environment of a temperature of 100° C. and a humidity of 10% RH. From the change in the time waveform of the photoelectric field before and after applying a voltage, Δn of the liquid crystal composition sealed in the glass cell was measured. An of the liquid crystal composition was 0.35.

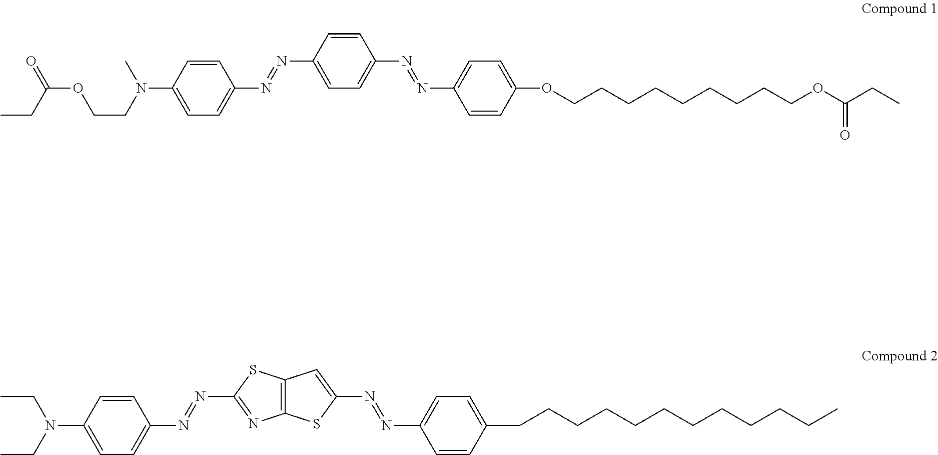

### COMPARATIVE EXAMPLE

An electromagnetic wave control element was modeled in the same manner as in Example 1, except that the liquid crystal compound used in the liquid crystal composition for forming a liquid crystal layer was changed to 4′-pentyl-4-biphenylcarbonitrile (5CB).

In addition, an optical system for transmissive type terahertz spectroscopy was manufactured by the same method as in Example, and a time waveform of the photoelectric field was measured in an environment of a temperature of 25° C. and a humidity of 10% RH. From the change in the time waveform of the photoelectric field before and after applying a voltage, Δn of the liquid crystal composition sealed in the glass cell was measured. Δn was 0.2.

### Evaluations

Using simulation software “COMSOL Multiphysics”, a reflection phase of electromagnetic waves at 100 GHz in a case where the electromagnetic waves at 100 GHz are incident on and reflected from the models of the electromagnetic wave control elements of Example and Comparative Example was calculated.

A difference in reflection phase with voltage application was calculated, based on calculations for each of a case where no voltage was applied and the liquid crystal compound LC was horizontally aligned and a case where a voltage was applied and the liquid crystal compound LC was vertically aligned. The calculations were each performed for a case where the film thickness of the liquid crystal layer was 10 to 300 μm, and a minimum film thickness with which the difference in reflection phase with voltage application was 180° was calculated.

In addition, it is known that the switching time in a case where a voltage is applied to the liquid crystal layer to change the alignment state of the liquid crystal compound is proportional to the square of the thickness.

The switching time of the electromagnetic wave control element of Comparative Example was set to 1, and the switching time of Example and Comparative Example was calculated.

The results are shown in Table 1 below.

TABLE 1

| | Film thickness with which | |
|---|---|---|
| | difference in reflection phase | |
| | with voltage application is 180° | Switching time |
| Example | 30 μm | 0.25 |
| Comparative Example | 60 μm | 1.0 |

From Table 1, it can be seen that in Example of the present invention, both the reduction in the switching time and the suppression of a loss of the electromagnetic waves can be achieved, as compared with Comparative Example.

The present invention can be suitably used for a beam steering device or the like.

### Explanation of References

10, 36: electromagnetic wave control element
12: metasurface structure
14, 100a: microstructure
16, 24: support body
20, 104: liquid crystal layer
26, 26A: first electrode layer
28: power supply
30: second electrode
32: first electrode
34: dielectric layer
LC: liquid crystal compound

What is claimed is:

1. An electromagnetic wave control element comprising:
a first electrode;
a liquid crystal layer in which an alignment state of a liquid crystal compound changes depending on a voltage; and
a metasurface structure in which a plurality of microstructures are arranged,
wherein the electromagnetic wave control element acts on electromagnetic waves having a frequency of 0.1 to 0.3 THz, and
the liquid crystal layer includes an azo compound.

2. The electromagnetic wave control element according to claim 1,
wherein the azo compound has two or more azo structures.

3. The electromagnetic wave control element according to claim 1,
wherein the liquid crystal layer includes a liquid crystal compound having an azo structure.

4. The electromagnetic wave control element according to claim 1, further comprising:
a second electrode constituting an electrode pair together with the first electrode.

5. The electromagnetic wave control element according to claim 4,
wherein at least one of the first electrode or the second electrode is the microstructure.

6. The electromagnetic wave control element according to claim 1,
wherein the microstructure constitutes an electrode pair together with the first electrode.

7. The electromagnetic wave control element according to claim 1,
wherein the first electrode reflects electromagnetic waves having a frequency of 0.1 to 0.3 THz.

8. The electromagnetic wave control element according to claim 1,
wherein the first electrode is a patterned electrode.

9. The electromagnetic wave control element according to claim 1,
wherein the microstructure includes a metal.

10. The electromagnetic wave control element according to claim 1,
wherein the microstructure includes an oxide semiconductor.

11. The electromagnetic wave control element according to claim 2,
wherein the liquid crystal layer includes a liquid crystal compound having an azo structure.

12. The electromagnetic wave control element according to claim 2, further comprising:
a second electrode constituting an electrode pair together with the first electrode.

13. The electromagnetic wave control element according to claim 12,
wherein at least one of the first electrode or the second electrode is the microstructure.

14. The electromagnetic wave control element according to claim 2,
wherein the microstructure constitutes an electrode pair together with the first electrode.

15. The electromagnetic wave control element according to claim 2,
wherein the first electrode reflects electromagnetic waves having a frequency of 0.1 to 0.3 THz.

16. The electromagnetic wave control element according to claim 2,
wherein the first electrode is a patterned electrode.

17. The electromagnetic wave control element according to claim 2,
wherein the microstructure includes a metal.

18. The electromagnetic wave control element according to claim 2,
wherein the microstructure includes an oxide semiconductor.

19. The electromagnetic wave control element according to claim 3, further comprising:
a second electrode constituting an electrode pair together with the first electrode.

20. The electromagnetic wave control element according to claim 19,
wherein at least one of the first electrode or the second electrode is the microstructure.
